(19) United States
(12) Patent Application Publication
(10) Pub. No.: US 2013/0030929 A1
(43) Pub. Date: Jan. 31, 2013

(54) RESERVE PRICE RANDOMNESS IN ONLINE ADVERTISING

(71) Applicant: Eric Theodore Bax, Altadena, CA (US)

(72) Inventor: Eric Theodore Bax, Altadena, CA (US)

(73) Assignee: Yahoo! Inc., Sunnyvale, CA (US)

(21) Appl. No.: 13/193,216

(22) Filed: Jul. 28, 2011

(51) Int. Cl. G06Q 30/00

(52) U.S. Cl. 705/14.71

(57) ABSTRACT

The present invention provides techniques that may be used in connection with or as part of an online advertising auction-based exchange. Techniques are provided in which reserve prices, which may set minimum amounts for winning bids, are randomized. For a set of one or more auctions during a time period to which a single reserve price would otherwise apply, one or more randomized reserve prices may instead be applied. Use of randomized reserve prices can smooth otherwise abrupt responses resulting from advertiser bid modifications, and lead to desirable marketplace characteristics or marketplace optimization.

### BACKGROUND

Auction-based exchanges are common in online advertising. In a broad sense, publishers (which term can include their representatives, agents, etc.) may submit ad calls, which may be opportunities to advertise. Advertisers (which term can include their representatives, agents, etc.) may submit bids to win auctions to advertise in connection with ad calls.

Exchanges may use reserve prices in their auctions. A reserve price may be, for example, a minimum allowable bid amount for a buyer in an auction. Offers with bids below the applicable reserve prices may be removed from the auction before the winner is selected, so that, in this or another way, offers below reserve prices cannot win those auctions.

Generally, an advertiser does not submit a bid applicable to a single auction or a small number of auctions. Instead, the advertiser generally submits a bid (which may including targeting conditions) applicable to a very large number of auctions over a period of time.

With regard to reserve pricing, supposing, as an example hypothetical, for a particular advertiser and over one or many periods of time, the same reserve price applies to many auctions in which a particular bid of the advertiser applies. A bid just below the reserve price will lose every auction. However, a bid at or above the reserve price may win many auctions, or, if it is further hypothetically supposed that no other bids are submitted for the auctions, a bid at or just above the reserve price will win all the auctions.

There is a need for improvements in, for example, online advertising auction design and mechanisms, including reserve pricing.

### SUMMARY

Some embodiments of the invention provide systems and methods that may be used in connection with or as part of an online advertising auction-based exchange. Techniques are provided in which reserve prices, which may set minimum amounts for winning bids, are randomized. For a set of one or more auctions during a time period to which a single reserve price would otherwise apply, one or more randomized reserve prices may instead be applied. Use of randomized reserve prices can smooth otherwise abrupt responses resulting from advertiser bid modifications, and lead to desirable marketplace characteristics or marketplace optimization.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

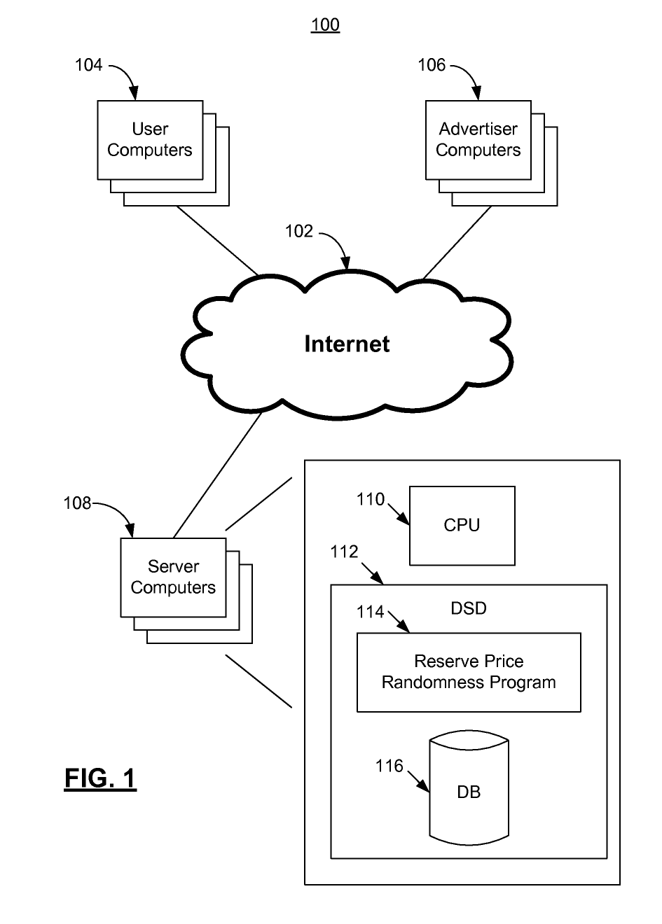

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and a Reserve Price Randomness Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

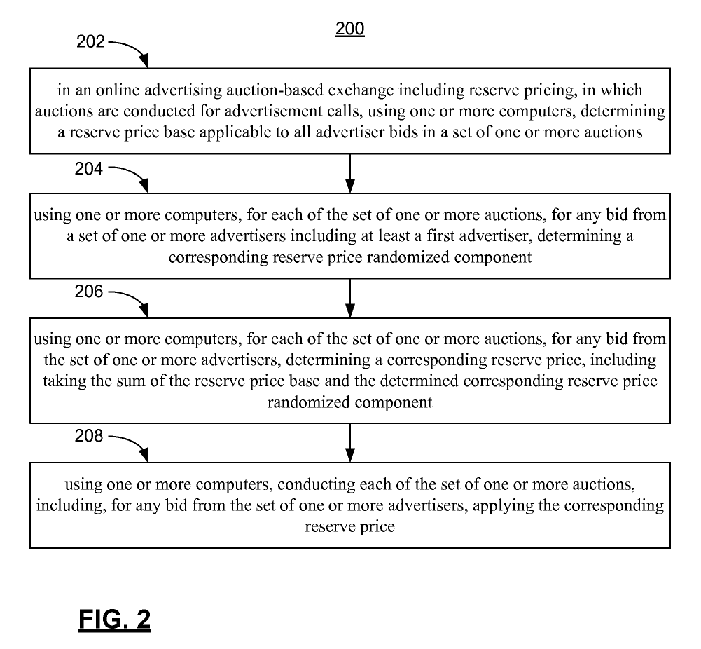

FIG. 2 is a flow diagram illustrating a method 200 according to one embodiment of the invention. At step 202, the method 200 includes, in an online advertising auction-based exchange including reserve pricing, in which auctions are conducted for advertisement calls, using one or more computers, determining a reserve price base applicable to all advertiser bids in a set of one or more auctions.

At step 204, the method includes, using one or more computers, for each of the set of one or more auctions, for any bid from a set of one or more advertisers including at least a first advertiser, determining a corresponding reserve price randomized component.

At step 206, the method 200 includes, using one or more computers, for each of the set of one or more auctions, for any bid from the set of one or more advertisers, determining a corresponding reserve price, including taking the sum of the reserve price base and the determined corresponding reserve price randomized component.

At step 208, the method 200 includes, using one or more computers, conducting each of the set of one or more auctions, including, for any bid from the set of one or more advertisers, applying the corresponding reserve price.

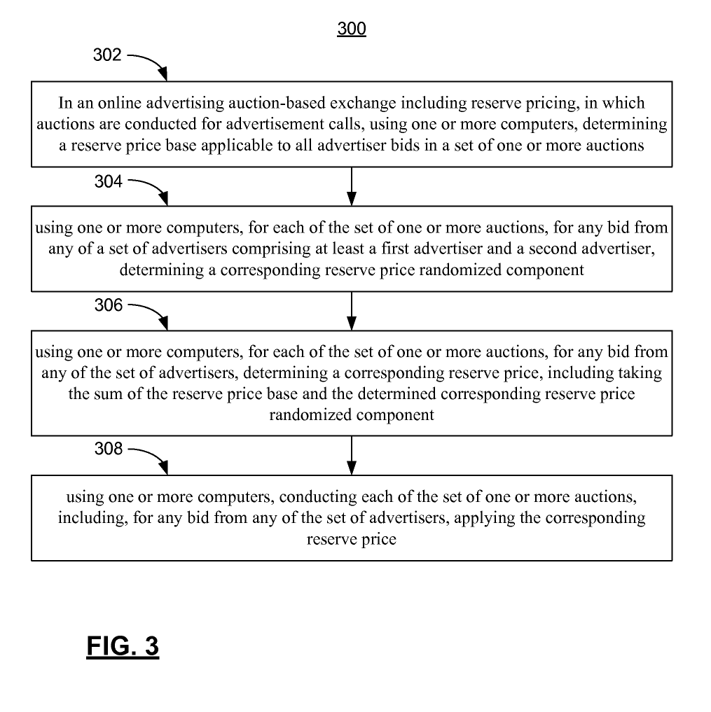

FIG. 3 is a flow diagram illustrating a method 300 according to one embodiment of the invention. At step 302, the method 300 includes, in an online advertising auction-based exchange including reserve pricing, in which auctions are conducted for advertisement calls, using one or more computers, determining a reserve price base applicable to all advertiser bids in a set of one or more auctions.

At step 304, the method 300 includes, using one or more computers, for each of the set of one or more auctions, for any bid from any of a set of advertisers comprising at least a first advertiser and a second advertiser, determining a corresponding reserve price randomized component.

At step 306, the method 300 includes, using one or more computers, for each of the set of one or more auctions, for any bid from any of the set of advertisers, determining a corresponding reserve price, including taking the sum of the reserve price base and the determined corresponding reserve price randomized component.

At step 308, the method 300 includes, using one or more computers, conducting each of the set of one or more auctions, including, for any bid from any of the set of advertisers, applying the corresponding reserve price.

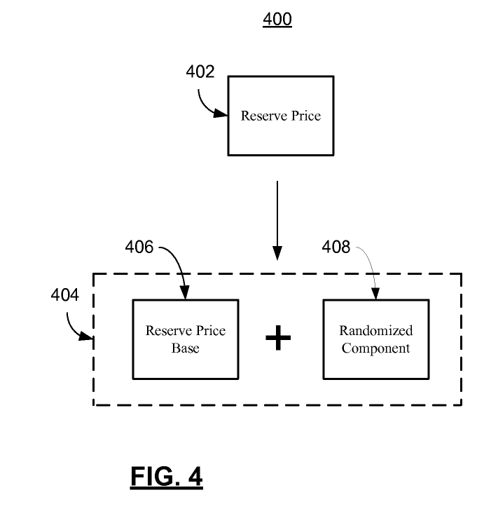

FIG. 4 is a block diagram 400 illustrating one embodiment of the invention. Block 402 represents a reserve price according to one embodiment of the invention. As represented by block 404, the reserve price is determined as the sum of a reserve price base 406 and a reserve price randomized component 408.

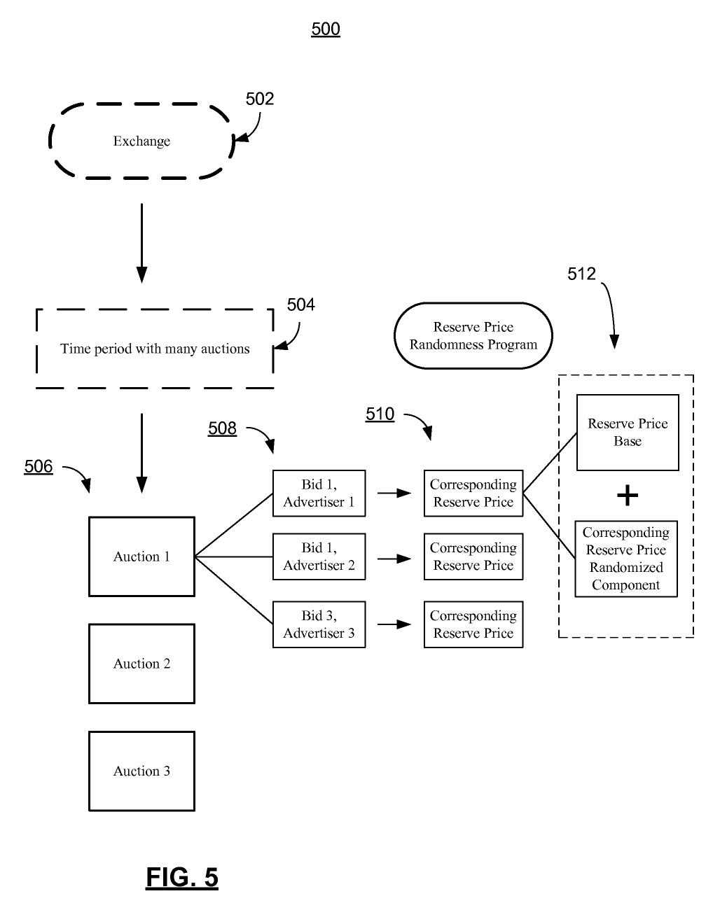

FIG. 5 is a block diagram 500 illustrating one embodiment of the invention. Block 502 represents an auction-based advertising exchange.

Block 504 represents a time period during which auctions are conducted. In some embodiments, advertisers may not change bids during the period.

Block 506 represents three of possibly many auctions that take place during the period.

Block 508 represents, for one particular auction, three of possibly many bids that are part of that auction.

Block 510 represents reserve prices applied to each of the bids 508. As represented by block 512, each bid may be determined as the sum of a reserve price base and a corresponding reserve price randomized component. In various embodiments, the randomized reserve prices for each bid may or may not vary based on the advertiser who submitted the bid, for example.

Some embodiments of the invention relate to setting of reserve prices in online advertising marketplaces, including auction-based exchanges. Much online advertising is bought through auctions. The sellers may be online publishers (which term can include their representatives or agents) and the buyers may be online advertisers (which term can include their representatives or agents).

Online advertising exchanges may be market-makers for online advertising. Broadly and generally, an exchange may function as follows. Advertisers may post offers, with each offer including a bid and targeting conditions, for example. Publishers may submit ad calls, which may be or relate to opportunities to advertise. For each ad call, the exchange may collect all offers for which the ad call meets targeting conditions. The market-maker may then conduct an auction. The offer with the highest bid may win, and the advertiser who posted that offer may be awarded the right to show an ad to a user through a page view, for example.

An exchange may conduct billions of auctions each day. An offer may participate in thousands or even millions of auctions a day. As such, the exchange may operate too quickly for advertisers to update their offers in response to winning or losing individual auctions. Instead, advertisers may adjust their bids based on the outcomes of multiple auctions, spanning time periods from hours to weeks, for example.

Exchanges may use reserve prices in their auctions. A reserve price may be, for example, a minimum allowable bid amount for a buyer in an auction. Offers with bids below their reserve prices may be, for example, removed from the auction before the winner is selected. Reserve prices may increase revenue for sellers by forcing or causing buyers to bid higher. They generally may be a significant component of classical auction mechanism design. As part of its mechanism design, the exchange may choose not to reveal reserve prices to advertisers.

In an exchange, suppose, for illustrative purposes, that a set of one or more auctions in each time period all have the same reserve price for an advertiser. If the advertiser starts with a bid below the reserve price and raises its bid in small increments, the advertiser may win no auctions at each increment until it tunes its bid up to the reserve price. The advertiser then may experience an abrupt increase in auctions won. In this case, the seller may run the risk that the advertiser will give up and stop bidding before reaching the reserve price. So the seller may lose revenue.

Similarly, suppose, for illustrative purposes, that the advertiser starts with a bid above its reserve price and there are no other advertisers with offers above that reserve price. The advertiser may then decrease its bid in small increments without winning any fewer auctions. As such, the advertiser may decrease its bid until it decreases below its reserve price, may lose all auctions in the set for the time period, and may then increment its bid to barely meet the reserve price. In this case, the advertiser's bid, which initially may have reflected the advertiser's value for each ad call, may now no longer reflect actual value. As a result, the exchange may offer less competition at prices above that reserve price, so new advertisers may not need to bid so much to win those auctions. In this case also, the seller may risk foregoing revenue.

Some embodiments of the invention introduce random variation in reserve prices, so that different individual auctions have different reserve prices, even for identical ad calls. In some embodiments, for example, starting with a base reserve price, for each auction, a random component is generated to add or subtract to form the reserve price for that auction.

The resulting variation may create a smoother response to bid changes. For example, if an advertiser bids more, then the advertiser may win a larger portion of the auctions. This may hold across a range of bids and bid changes.

In some embodiments, for example, with random adjustments, the advertiser who bids below the base reserve price may still win some auctions. Also, the number won may increase, on average, as the advertiser increases its bid. Resulting feedback may make it possible for advertisers to interpolate and extrapolate about the relationship between bids and auctions won, making it easier for them to optimize their buying. As a result, they may be less likely to give up on bidding.

Consider, for example, the advertiser who begins with a bid above the nominal reserve price. In some embodiments, for example, under random variation, if the advertiser reduces their bid, it may win fewer auctions, even if it does not reduce the bid below the nominal reserve price. So the advertiser may have an incentive to maintain their high bid, offering competition to new advertisers.

While the invention is described with reference to the above drawings, the drawings are intended to be illustrative, and the invention contemplates other embodiments within the spirit of the invention.

1. In an online advertising auction-based exchange including reserve pricing, in which auctions are conducted for advertisement calls, a method comprising:
using one or more computers, determining a reserve price base applicable to all advertiser bids in a set of one or more auctions;
using one or more computers, for each of the set of one or more auctions, for any bid from a set of one or more advertisers comprising at least a first advertiser, determining a corresponding reserve price randomized component;
using one or more computers, for each of the set of one or more auctions, for any bid from the set of one or more advertisers, determining a corresponding reserve price, comprising taking the sum of the reserve price base and the determined corresponding reserve price randomized component; and
using one or more computers, conducting each of the set of one or more auctions, comprising, for any bid from the set of one or more advertisers, applying the corresponding reserve price.

2. The method of claim 1, wherein reserve prices are determined on a per-auction basis, with a single reserve price determined as a reserve price for a particular auction, and wherein the reserve price for the particular auction is applied to all bids in the particular auction.

3. The method of claim 1, comprising conducting each of the set of one or more auctions, wherein the set of one or more advertisers consists of the first advertiser.

4. The method of claim 1, comprising conducting each of the set of one or more auctions, wherein the set of one or more advertisers comprises all advertisers with any bid in any of the set of one or more auctions.

5. The method of claim 1, comprising conducting each of the set of one or more auctions, wherein the set of one or more advertisers comprises at least a first advertiser and a second advertiser, and wherein, for at least a first auction of the set of one or more auctions, a corresponding randomized component for a bid from the first advertiser is different than a corresponding randomized component for a bid from the second advertiser.

6. The method of claim 1, comprising conducting each of the set of one or more auctions, wherein the set of one or more advertisers comprises at least a first advertiser and a second advertiser, and wherein, for a first auction of the set of one or more auctions, a corresponding randomized component for a bid from the first advertiser is determined differently than a corresponding randomized component for a bid from the second advertiser.

7. The method of claim 1, wherein determining a reserve price randomized component comprises determining a reserve price randomized component wherein the reserve price randomized component can be positive or negative.

8. The method of claim 1, wherein determining a reserve price randomized component comprises determining a reserve price randomized component wherein the reserve price randomized component is randomized but subject to parameters comprising a maximum positive amount and a maximum negative amount.

9. The method of claim 1, wherein determining a reserve price randomized component comprises determining a reserve price randomized component wherein the reserve price randomized component is randomized but subject to parameters including a defined distribution.

10. The method of claim 1, comprising conducting each of the set of one or more auctions, wherein reserve price randomized components are utilized in optimizing one or more market conditions relating to the exchange.

11. The method of claim 1, comprising conducting each of the set of one or more auctions, wherein reserve price randomized components are utilized in maximizing or optimizing publisher revenue relating to the set of one or more auctions.

12. The method of claim 1, comprising conducting each of the set of one or more auctions, wherein one or more formulas utilized in calculating reserve price randomized components for bids from a particular advertiser are selected to be optimized in one or more ways with respect to the particular advertiser.

13. The method of claim 1, comprising conducting each of the set of one or more auctions, wherein the exchange comprises a display advertising exchange.

14. The method of claim 1, comprising conducting each of the set of one or more auctions, wherein the exchange comprises a keyword-based advertising exchange.

15. A system comprising:
one or more server computers coupled to a network; and
one or more databases coupled to the one or more server computers;
wherein the one or more server computers are for:
determining a reserve price base applicable to all advertiser bids in a set of one or more auctions;
for each of the set of one or more auctions, for any bid from a set of one or more advertisers comprising at least a first advertiser, determining a corresponding reserve price randomized component;
for each of the set of one or more auctions, for any bid from the set of one or more advertisers, determining a corresponding reserve price, comprising taking the sum of the reserve price base and the determined corresponding reserve price randomized component; and
conducting each of the set of one or more auctions, comprising, for any bid from the set of one or more advertisers, applying the corresponding reserve price.

16. The system of claim 15, wherein the set of one or more advertisers consists of the first advertiser.

17. The system of claim 15, wherein the set of one or more advertisers comprises all advertisers with any bid in any of the set of one or more auctions.

18. The system of claim 15, wherein the set of one or more advertisers comprises at least a first advertiser and a second advertiser, and wherein, for a first auction of the set of one or more auctions, a corresponding randomized component for a bid from the first advertiser is different than a corresponding randomized component for a bid from the second advertiser.

19. The system of claim 15, wherein the set of one or more advertisers comprises at least a first advertiser and a second advertiser, and wherein, for a first auction of the set of one or more auctions, a corresponding randomized component for a bid from the first advertiser is determined differently than a corresponding randomized component for a bid from the second advertiser.

20. A computer readable medium or media containing instructions for executing a method in an online advertising auction-based exchange including reserve pricing, in which auctions are conducted for advertisement calls, the method comprising:
using one or more computers, determining a reserve price base applicable to all advertiser bids in a set of one or more auctions;
using one or more computers, for each of the set of one or more auctions, for any bid from any of a set of advertisers comprising at least a first advertiser and a second advertiser, determining a corresponding reserve price randomized component;
using one or more computers, for each of the set of one or more auctions, for any bid from any of the set of advertisers, determining a corresponding reserve price, comprising taking the sum of the reserve price base and the determined corresponding reserve price randomized component,
wherein, for at least a first auction of the set of one or more auctions, a corresponding randomized component for a bid from the first advertiser is different than a corresponding randomized component for a bid from the second advertiser; and
using one or more computers, conducting each of the set of one or more auctions, comprising, for any bid from any of the set of advertisers, applying the corresponding reserve price.
